(19) United States
(12) Patent Application Publication
(10) Pub. No.: US 2022/0289234 A1
(43) Pub. Date: Sep. 15, 2022

(54) AUTONOMOUS DRIVING CONTROL METHOD, AUTONOMOUS DRIVING CONTROL SYSTEM, AND VEHICLE

(71) Applicant: NIO TECHNOLOGY (ANHUI) CO., LTD, Hefei City (CN)

(72) Inventors: Xianhui ZHANG, Hefei City (CN); Da YUAN, Hefei City (CN); Chao XU, Hefei City (CN); Baotian WANG, Hefei City (CN); Shengwei DENG, Hefei City (CN); Bohong XIAO, Hefei City (CN)

(21) Appl. No.: 17/690,631

(22) Filed: Mar. 9, 2022

(30) Foreign Application Priority Data
Mar. 11, 2021 (CN) 202110266391.1

(51) Int. Cl. B60W 60/00; B60W 50/08; B60W 40/10; B60W 40/13

(52) U.S. Cl. CPC B60W 60/001; B60W 50/082; B60W 40/10; B60W 40/13; B60W 2510/222; B60W 2510/18

(57) ABSTRACT

The invention relates to an autonomous driving control method, an autonomous driving control system, and a vehicle. The autonomous driving control method includes: estimating motion control capacities of a vehicle on the basis of performance parameters and/or structure parameters of the vehicle; grading autonomous driving functions of the vehicle on the basis of the motion control capacities; and providing the graded autonomous driving functions on the basis of a state of the vehicle. The autonomous driving control method of the invention can provide different grades of autonomous driving functions in different vehicle states, thereby improving driving experience.

### CROSS-REFERENCE TO RELATED APPLICATION

This application claims the benefit of China Patent Application No. 202110266391.1 filed on Mar. 11, 2021, the entire contents of which are incorporated herein by reference in its entirety.

### TECHNICAL FIELD

The invention relates to the field of autonomous driving, and in particular to an autonomous driving control method, an autonomous driving control system, and a vehicle.

### BACKGROUND ART

At present, motion control over a vehicle mainly includes: braking control, drive control, steering control, and suspension control. Autonomous driving functions generally relate to the test of controllers for vehicle motion control. When a controller is faulty but still has a control capacity, an autonomous driving control system generally prohibits the autonomous driving functions from being enabled or directly exits the autonomous driving functions, such that when the controller fails, a high-level autonomous driving function is unavailable and a low-level autonomous driving function is also prohibited from being enabled. In addition, when a high-level autonomous driving function is activated, if the vehicle motion controller fails, it cannot be downgraded to a low-level autonomous driving function but is directly transferred to a driver to take over.

Therefore, it is urgent to seek an autonomous driving control method to solve the above problems.

### SUMMARY OF THE INVENTION

In view of this, according to a first aspect of the invention, an autonomous driving control method is provided, for effectively solving the above problems and other problems in the prior art. The autonomous driving control method comprises:
estimating motion control capacities of a vehicle on the basis of performance parameters and/or structure parameters of the vehicle;
grading autonomous driving functions of the vehicle on the basis of the motion control capacities; and
providing the graded autonomous driving functions on the basis of a state of the vehicle.

Optionally, in the autonomous driving control method as described above, the motion control capacities of the vehicle comprise an acceleration capacity, a deceleration capacity, a steering capacity, a parking capacity, and a suspension capacity.

Optionally, in the autonomous driving control method as described above, the performance parameters comprise: a road adhesion coefficient, a battery charge and discharge performance, an electric motor drive performance, an input of a steering system, a steering control performance fed back by a brake system, a state of an electronic parking system, a brake torque of the brake system, a braking torque of an electric motor, and a state of a suspension system; and
the structure parameters comprise: vehicle weight and a location of the center of mass.

Optionally, in the autonomous driving control method as described above, estimating motion control capacities of a vehicle on the basis of performance parameters and/or structure parameters of the vehicle comprises:
calculating an available adhesion force for each tire of the vehicle on the basis of the road adhesion coefficient, the vehicle weight and the location of the center of mass; and
calculating a maximum acceleration and a maximum deceleration of the vehicle on the basis of the adhesion force, the battery charge and discharge performance and the electric motor drive performance, to estimate the acceleration capacity and the deceleration capacity.

Optionally, in the autonomous driving control method as described above, estimating motion control capacities of a vehicle on the basis of performance parameters and/or structure parameters of the vehicle comprises:
calculating an available adhesion force for each tire of the vehicle on the basis of the road adhesion coefficient, the vehicle weight and the location of the center of mass; and
calculating a maximum steering of the vehicle on the basis of the adhesion force, the input of the steering system and the steering control performance fed back by the brake system, to estimate the steering capacity.

Optionally, in the autonomous driving control method as described above, estimating motion control capacities of a vehicle on the basis of performance parameters and/or structure parameters of the vehicle comprises:
computing available parking function states of the vehicle on the basis of the state of the electronic parking system, the brake torque of the brake system and the braking torque of the electric motor, to estimate the parking capacity,
wherein the parking function states comprise a full-function execution state, a five-minute execution state, and a non-execution state.

Optionally, in the autonomous driving control method as described above, estimating motion control capacities of a vehicle on the basis of performance parameters and/or structure parameters of the vehicle comprises:
estimating a state of a suspension stiffness control capacity of the vehicle on the basis of the state of the suspension system, to estimate the suspension capacity.

According to a second aspect of the invention, an autonomous driving control system is provided. The autonomous driving control system comprises:
an estimating module configured to estimate motion control capacities of a vehicle on the basis of performance parameters and/or structure parameters of the vehicle;
a grading module configured to grade autonomous driving functions of the vehicle on the basis of the motion control capacities; and
an autonomous driving function providing module configured to provide the graded autonomous driving functions on the basis of a state of the vehicle.

Optionally, in the autonomous driving control system as described above, the estimating module comprises: a road adhesion force estimation unit, an electric motor estimation unit, a battery estimation unit, a braking estimation unit, a steering estimation unit, a parking estimation unit, and a suspension estimation unit.

According to a third aspect of the invention, a vehicle is provided, comprising the autonomous driving control system described above.

It can be appreciated that the autonomous driving control method of the invention can provide the motion control capacities of the vehicle in real time, give play to the maximum performance of each controller, and support better grading of the autonomous driving functions, so as to provide different grades of autonomous driving functions in different vehicle states to improve driving experience.

### BRIEF DESCRIPTION OF THE DRAWINGS

The disclosure of the invention will become more readily understood with reference to the accompanying drawings. Those skilled in the art will readily appreciate that the accompanying drawings are merely for illustrative purposes and are not intended to limit the scope of protection of the invention. In addition, like components are indicated by like numbers in the figures, in which:

FIG. 1 is a flowchart showing an autonomous driving control method according to an exemplary embodiment of the invention;

FIG. 2 is a schematic block diagram showing an autonomous driving control system according to an exemplary embodiment of the invention; and

FIG. 3 is a schematic block diagram showing an estimating module of an autonomous driving control system according to an exemplary embodiment of the invention.

### DETAILED DESCRIPTION OF EMBODIMENTS

In the disclosure, unless otherwise stated, the terms “first”, “second”, etc., used to describe various elements are not intended to limit the positional, temporal or importance relationship of these elements, but rather only to distinguish one component from the other. In some embodiments, a first element and a second element may refer to the same instance of the element, and in some cases, based on contextual descriptions, the first element and the second element may also refer to different instances.

The terms used in the description of the various examples in the disclosure are merely for the purpose of describing particular examples, and are not intended to be limiting. Unless the context clearly dictates otherwise, if the number of elements is not expressly limited, there may be one or more elements. In addition, as used in the disclosure, the term “and/or” encompasses any and all possible combinations of the listed items.

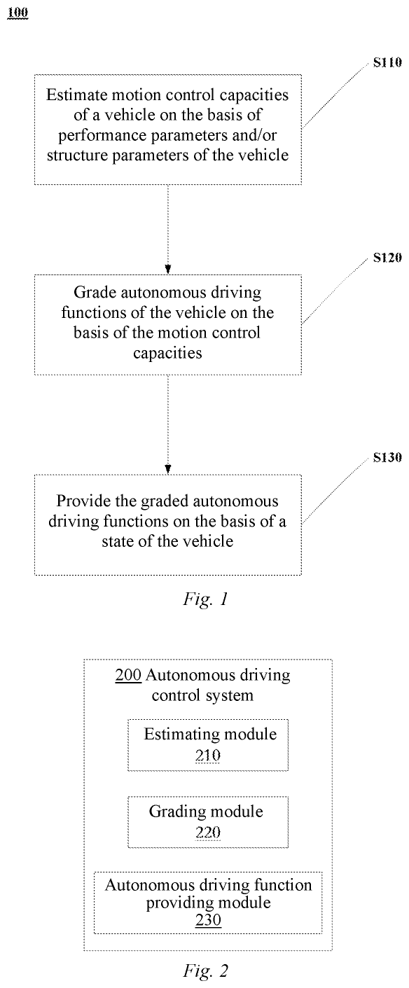

FIG. 1 shows a flowchart of an autonomous driving control method 100 according to an embodiment of the disclosure. Hereinafter, as a non-limited example, the vehicle is considered to be a type of motor vehicle, for example, refers to a car, a coach, a truck, or a commercial vehicle. However, the disclosure is not limited to this type of vehicle. The disclosure relates to any type of land vehicle that can be moved and driven on the ground and can be parked in or leave a parking area.

Referring to FIG. 1, the autonomous driving control method 100 includes: estimating motion control capacities of a vehicle on the basis of performance parameters and/or structure parameters of the vehicle (step S110); grading autonomous driving functions of the vehicle on the basis of the motion control capacities (step S120); and providing the graded autonomous driving functions on the basis of a state of the vehicle (step S130).

FIG. 2 shows a schematic block diagram of an autonomous driving control system 200 according to an embodiment of the invention. Referring to FIG. 2, the autonomous driving control system 200 includes an estimating module 210, a grading module 220, and an autonomous driving function providing module 230.

For the purpose of illustration, the autonomous driving control method 100 is described below with reference to FIGS. 1 and 2.

In step S110, the motion control capacities of the vehicle are estimated on the basis of performance parameters and/or structure parameters of the vehicle. In some embodiments, step S110 is implemented by the estimating module 210. Specifically, the estimating module 210 estimates the motion control capacities of the vehicle on the basis of the performance parameters and/or the structure parameters of the vehicle. As an example, the motion control capacities of the vehicle generally include an acceleration capacity, a deceleration capacity, a steering capacity, a parking capacity, and a suspension capacity. The performance parameters include: a road adhesion coefficient, a battery charge and discharge performance, an electric motor drive performance, an input of a steering system, a steering control performance fed back by a brake system, a state of an electronic parking system, a brake torque of the brake system, a braking torque of an electric motor, a state of a suspension system, etc. The structure parameters are related to the structure of the vehicle itself, including: vehicle weight, a location of the center of mass, etc.

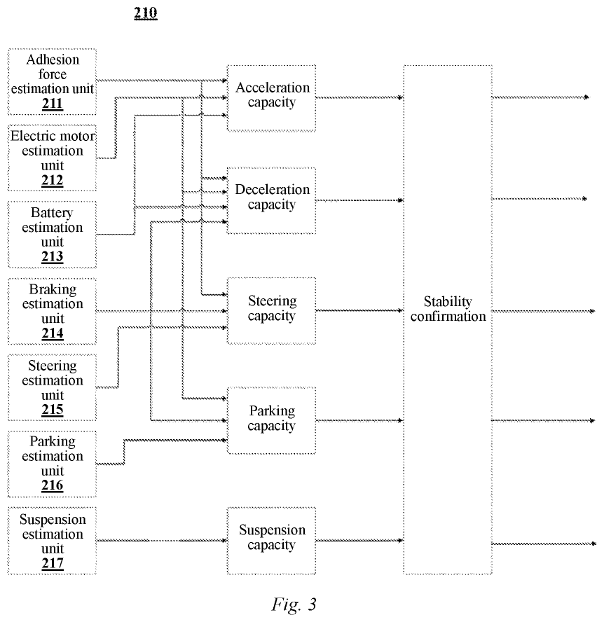

Further referring to FIG. 3 , the estimating module 210 of the autonomous driving control system 200 includes: an adhesion force estimation unit 211 configured to estimate a road adhesion force; an electric motor estimation unit 212 configured to estimate a drive torque and a braking torque of an electric motor; a battery estimating module 213 configured to estimate a torque corresponding to a battery charge and discharge capacity; a brake estimation unit 214 configured to estimate a braking torque of a brake; a steering estimation unit 215 configured to estimate a capacity of a steering system; a parking estimation unit 216 configured to estimate a state of a parking system; and a suspension estimation unit 217 configured to estimate a suspension control state. According to the invention, the autonomous driving control system estimates the motion control capacities of the vehicle from the vehicle system level, and synergizes various controllers of the vehicle during motion control estimation. The following will describe for the specific motion control capacities.

For the acceleration capacity and the deceleration capacity of the vehicle, step S110 includes: calculating an available adhesion force for each tire of the vehicle on the basis of the road adhesion coefficient, the vehicle weight and the location of the center of mass; and calculating a maximum acceleration and a maximum deceleration of the vehicle on the basis of the adhesion force, the battery charge and discharge performance and the electric motor drive performance, to estimate the acceleration capacity and the deceleration capacity. In this case, the acceleration capacity and the deceleration capacity of the vehicle are estimated by means of the adhesion force estimation unit 211, the electric motor estimation unit 212 and the battery estimation unit 213.

For the steering capacity of the vehicle, step S110 includes: calculating an available adhesion force for each tire of the vehicle on the basis of the road adhesion coefficient, the vehicle weight and the location of the center of mass; and calculating a maximum steering of the vehicle on the basis of the adhesion force, the input of the steering system and the steering control performance fed back by the brake system, to estimate the steering capacity. In this case, the steering capacity of the vehicle is estimated by means of the adhesion force estimation unit 211, the braking estimation unit 214 and the steering estimation unit 215.

For the parking capacity of the vehicle, step S110 includes: computing available parking function states of the vehicle on the basis of the state of the electronic parking system, the brake torque of the brake system and the braking torque of the electric motor, to estimate the parking capacity. The parking function states include a full-function execution state, a five-minute execution state, and a non-execution state. In this case, the parking capacity of the vehicle is estimated by means of the electric motor estimation unit 212 and the parking estimation unit 216.

For the suspension capacity of the vehicle, step S110 includes: estimating a state of a suspension stiffness control capacity of the vehicle on the basis of the state of the suspension system, to estimate the suspension capacity. In this case, the suspension capacity of the vehicle is estimated by means of the suspension estimation unit 217.

In the above, by estimating road conditions, the location of the center of gravity and the vehicle weight in conjunction with feedbacks of capacities of executors, the acceleration capacity, the deceleration capacity, the steering capacity, the parking capacity, and the suspension capacity of the vehicle are estimated from the vehicle level. An estimation result obtained can be output as a final estimation result of the various motion control capacities after performing “stability confirmation” (see FIG. 3).

In step S120, autonomous driving functions of the vehicle are graded on the basis of the motion control capacities. In some embodiments, step S120 is implemented by the grading module 220. Specifically, the grading module 220 grades the autonomous driving functions of the vehicle on the basis of the final estimation result of the motion control capacities mentioned above. For example, if the motion control capacities of the vehicle including the acceleration capacity, the deceleration capacity, the steering capacity, the parking capacity and the suspension capacity are estimated by the estimating module 210, and only the parking capacity is poor, then the grading module 220 may grade the autonomous driving function related to parking as a low-level autonomous driving function, and grade the autonomous driving functions related to acceleration, deceleration, steering, and suspension as high-level autonomous driving functions. Through the motion control estimation under the synergy of multiple controllers mentioned above, providing the vehicle motion control capacities to the autonomous driving control system without increasing the hardware cost is ensured, and better grading of the autonomous driving functions is supported.

In step S130, the graded autonomous driving functions are provided on the basis of a state of the vehicle. In some embodiments, step S130 is implemented by the autonomous driving function providing module 230. Specifically, the autonomous driving function providing module 230 provides the graded autonomous driving functions on the basis of the state of the vehicle. That is, after the autonomous driving functions are graded, the autonomous driving control system provides different grades of autonomous driving functions for different states of the vehicle (for instance, when the vehicle accelerates, decelerates, turns or parks). For example, when the autonomous driving function related to parking is graded low, and the autonomous driving functions related to acceleration, deceleration, steering and suspension are graded high, function downgrading may be carried out during parking of the vehicle, and a driver takes over the steering wheel. The high-level autonomous driving functions of the vehicle can still maintain normal operation during acceleration, deceleration and steering, such that the high-level autonomous driving functions of the vehicle are prevented from directly exiting, thereby facilitating providing of different grades of autonomous driving functions in different vehicle states, and significantly improving experience of using the autonomous driving functions.

According to another aspect of the disclosure, the above-mentioned autonomous driving control system 200 is also provided, which includes an estimating module 210, a grading module 220, and an autonomous driving function providing module 230.

The estimating module 210 is configured to estimate motion control capacities of a vehicle on the basis of performance parameters and/or structure parameters of the vehicle;
the grading module 220 is configured to grade autonomous driving functions of the vehicle on the basis of the motion control capacities; and
the autonomous driving function providing module 230 is configured to provide the graded autonomous driving functions on the basis of a state of the vehicle.

The operations of the various modules of the autonomous driving control system 200 have been described in detail above with respect to the embodiment of the autonomous driving control method in FIG. 1, and will not be described in detail for the sake of concision. It will be appreciated that the autonomous driving control system 200 can have the same advantages as the embodiment of autonomous driving control method described above.

In addition, although specific functions are discussed above with reference to specific modules, it should be noted that the functions of each module discussed herein may be divided into a plurality of modules, and/or at least some functions of the plurality of modules may be combined into a single module. The specific modules that perform an action discussed herein include the specific module itself performing the action, or alternatively the specific modules call or otherwise access another component or module that performs the action (or performs the action in combination with the specific modules). Therefore, the specific modules that perform the action may include the specific modules that perform the action themselves and/or another module that is called or otherwise accessed by the specific modules that perform the action.

According to still another aspect of the disclosure, a vehicle is also provided. The vehicle according to an embodiment of the disclosure may include the autonomous driving control system 200 as described above. According to some embodiments, the autonomous driving control method 100 described above may be implemented on the vehicle.

Several specific embodiments are listed above to detail the autonomous driving method, the autonomous driving control system, and the vehicle, and these examples are only for explaining the principle of the invention and the implementations thereof, rather than limiting the invention; and those of ordinary skill in the art can make various modifications and improvements without departing from the spirit and scope of the invention. Therefore, all equivalent technical solutions should fall within the scope of the invention and be defined by the claims of the invention.

1. An autonomous driving control method, comprising:
estimating motion control capacities of a vehicle on the basis of performance parameters and/or structure parameters of the vehicle;
grading autonomous driving functions of the vehicle on the basis of the motion control capacities; and
providing the graded autonomous driving functions on the basis of a state of the vehicle.

2. The autonomous driving control method according to claim 1, wherein the motion control capacities of the vehicle comprise an acceleration capacity, a deceleration capacity, a steering capacity, a parking capacity, and a suspension capacity.

3. The autonomous driving control method according to claim 2, wherein the performance parameters comprise: a road adhesion coefficient, a battery charge and discharge performance, an electric motor drive performance, an input of a steering system, a steering control performance fed back by a brake system, a state of an electronic parking system, a brake torque of the brake system, a braking torque of an electric motor, and a state of a suspension system; and
the structure parameters comprise: vehicle weight and a location of the center of mass.

4. The autonomous driving control method according to claim 3, wherein estimating motion control capacities of a vehicle on the basis of performance parameters and/or structure parameters of the vehicle comprises:
calculating an available adhesion force for each tire of the vehicle on the basis of the road adhesion coefficient, the vehicle weight and the location of the center of mass; and
calculating a maximum acceleration and a maximum deceleration of the vehicle on the basis of the adhesion force, the battery charge and discharge performance and the electric motor drive performance, to estimate the acceleration capacity and the deceleration capacity.

5. The autonomous driving control method according to claim 3, wherein estimating motion control capacities of a vehicle on the basis of performance parameters and/or structure parameters of the vehicle comprises:
calculating an available adhesion force for each tire of the vehicle on the basis of the road adhesion coefficient, the vehicle weight and the location of the center of mass; and
calculating a maximum steering of the vehicle on the basis of the adhesion force, the input of the steering system and the steering control performance fed back by the brake system, to estimate the steering capacity.

6. The autonomous driving control method according to claim 3, wherein estimating motion control capacities of a vehicle on the basis of performance parameters and/or structure parameters of the vehicle comprises:
computing available parking function states of the vehicle on the basis of the state of the electronic parking system, the brake torque of the brake system and the braking torque of the electric motor, to estimate the parking capacity, wherein the parking function states comprise a full-function execution state, a five-minute execution state, and a non-execution state.

7. The autonomous driving control method according to claim 3, wherein estimating motion control capacities of a vehicle on the basis of performance parameters and/or structure parameters of the vehicle comprises:
estimating a state of a suspension stiffness control capacity of the vehicle on the basis of the state of the suspension system, to estimate the suspension capacity.

8. An autonomous driving control system, comprising:
an estimating module configured to estimate motion control capacities of a vehicle on the basis of performance parameters and/or structure parameters of the vehicle;
a grading module configured to grade autonomous driving functions of the vehicle on the basis of the motion control capacities; and
an autonomous driving function providing module configured to provide the graded autonomous driving functions on the basis of a state of the vehicle.

9. The autonomous driving control system according to claim 8, wherein the estimating module comprises: an adhesion force estimation unit, an electric motor estimation unit, a battery estimation unit, a braking estimation unit, a steering estimation unit, a parking estimation unit, and a suspension estimation unit.

10. A vehicle, comprising the autonomous driving control system according to claim 8.
